(19) United States
(12) Patent Application Publication
(10) Pub. No.: US 2009/0097462 A1
(43) Pub. Date: Apr. 16, 2009

(54) Deployable Cellular Communication Extension System

(75) Inventors: Declan J. Ganley, Galway (IE); James O'Reilly, Galway (IE); Clint Smith, Warwich, NY (US); Michael Mark, Colorado Springs, CO (US)

Correspondence Address: The Marbury Law Group, PLLC, 11800 Sunrise Valley Drive, Suite 1000, Reston, VA, 20191, US

(73) Assignee: RIVADA NETWORKS, LLC, Arlington, VA (US)

(21) Appl. No.: 12/249,143

(22) Filed: Oct. 10, 2008

Related U.S. Application Data
(60) Provisional application No. 60/979,341, filed on Oct. 11, 2007.

(51) Int. Cl. H04W 88/00

(52) U.S. Cl. 370/338

(57) ABSTRACT

Embodiments of systems and methods provide deployable cellular telecommunication base stations capable of sending, receiving, and extending telephone calls in areas where commercial cellular communications are unavailable. The deployable base station can send and receive cellular telephone calls via cellular communication transceivers, and relay such calls to a distant teleport via a satellite communication link. The deployable base station includes routers for encoding voice calls in voice-over IP data format and for routing calls via the satellite communication link. The deployable base station may also include land mobile radio (LMR) communication interoperability circuits to enable LMR communications to be relayed to a distant teleport. At the teleport, received communications can be routed via a public switched telephone network to an intended receiver to enable telephone communications with the global commercial network from areas lacking commercial cellular communications.

This application claims the benefit of priority to U.S. Provisional Patent Application No. 60/979,341 filed Oct. 11, 2007, the entire contents of which are hereby incorporated by reference.

### FIELD OF THE INVENTION

The present invention relates to telecommunications systems in general, and more particularly a deployable cellular communication extension system that can be deployed to augment or replace cellular communication system infrastructure.

### BACKGROUND

During emergencies such as terrorist events, hurricanes, and earthquakes local telecommunications infrastructure can be disrupted and overloaded. For example, in the aftermath of hurricane Katrina, emergency personnel responding to the disaster were hobbled by the collapse of the New Orleans cellular communication infrastructure. Those cellular communications assets that remained functional were quickly overwhelmed by heavy use. Recent evaluations of public safety networks in the United States and Europe following recent terrorist events and natural disasters have highlighted significant deficiencies. These deficiencies include the inability of government agencies, military forces, and first responders to exchange information across functional, service, and geographic boundaries due to non-interoperability; and an inability to utilize new technologies such as still image capture, video, position location, and IP push-to-talk due to the use of legacy LMR networks and equipment. Consequently, there is a need for systems and methods for rapidly augmenting or replacing cellular communications infrastructure at emergency locations.

### SUMMARY

The various embodiments provide a deployable cellular communication system that can augment or replace cellular communication assets, thereby providing temporary additional or replacement communications infrastructure. The embodiments also encompass a cellular communication system including both conventional fixed cellular communication assets and one or more deployable communication extension system. The embodiments also include methods for deploying a communication extension system and operating a deployed communication extension system in conjunction with conventional fixed cellular communication assets.

### BRIEF DESCRIPTION OF THE DRAWINGS

The features and nature of the present invention will become more apparent from the detailed description set forth below when taken in conjunction with the drawings in which like reference characters identify correspondingly throughout and wherein:

FIG. 1 is a system block diagram of an embodiment of the present invention.

FIG. 2 is a system block diagram of the embodiment shown in FIG. 1 illustrating call routing through the system.

FIG. 3 is a system block diagram of the embodiment shown in FIG. 1 illustrating call routing and data signalling through the system.

FIG. 4 is a system block diagram of a network operation center embodiment suitable for use with the system.

FIG. 5 is a system block diagram shown communication and component details for an example embodiment.

FIG. 6 is a system block diagram of a portion of the system showing components included in an example embodiment.

FIG. 7 is a schematic of equipment racks of a system embodiment.

FIG. 8 is a module block diagram showing relationships of data systems and communications providers of a system embodiment.

FIG. 9 is a system block diagram of another system embodiment.

FIG. 10 is a system block diagram illustrating a communication path for Internet data communicated via an embodiment.

FIG. 11 is a system block diagram illustrating communication paths for voice, authentication and signalling communications according to an embodiment.

FIG. 12 is a system block diagram illustrating different data compression protocols utilized through different communication paths according to an embodiment.

FIG. 13 is a system block diagram illustrating call flows according to an embodiment.

FIG. 14-19 are communication system architecture diagrams illustrating example communication structures that may be implemented according to embodiments.

### DETAILED DESCRIPTION

The various embodiments will be described in detail with reference to the accompanying drawings. Wherever possible, the same reference numbers will be used throughout the drawings to refer to the same or like parts.

In overview, the various embodiments include a deployable cell base station including a satellite terminal, a radio bridge, and field mobile subscriber equipment. For ease of reference, this equipment may be referred to herein as a deployable base station and as an interim communication extension system (“ICE-S”). Such equipment may be deployed singularly, or in groups, such as three units. When deployed, the resulting interim communication extension system can be employed by first responder, state and local police, fire and rescue, emergency management, national guard and military subordinate and component commands. Some civilian use may also be provided.

Deployable base stations can be capable and can be programmed for multi-sector operation (up to three sectors), with localized switch, home location registry, and capable of operating in a high latency environment typically (900 ms>latency>300 ms) such as over satellite. Current deployable base stations are omni (one sector) systems. As an option, systems can be upgraded to multi-sector.

The cellular voice systems support standard CDMA voice as well as providing specific support to secure cell phones that are compatible with the cellular base stations.

Each deployable base station can be capable of exchanging and synchronizing (send and receive) its Home Location Registry (HLR) data with previously fielded systems and a centralized network operation center (NOC). This mobility feature allows mobile subscribers to seamlessly roam from deployed base station to deployed base station, as well as to commercial carriers.

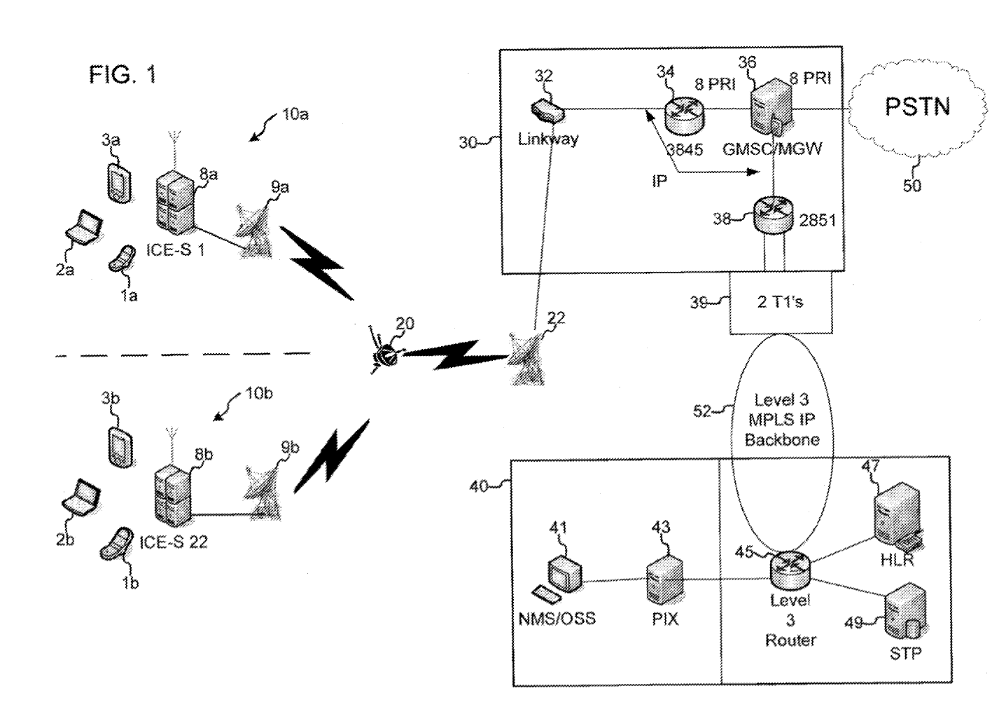

Satellite communication links enable deployable base station platforms to be fully interoperable with a variety of networks and systems. A typical communication network and communication routing are illustrated in FIGS. 1-3. Deployable base stations may be capable of sending, receiving, and extending telephone calls (e.g., IS-41 messaging) to users affiliated with its own switch as well as other similar systems. The deployable base station satellite backhaul capability may include satellite KU band VSATs that are auto track capable. The current ICE-S systems can be fielded and supported through a teleport.

Each system can be managed with its capability of internetworking, public switched telephone network (PTSN), or the Defense Switched Network (DSN) as well as commercial Internet or NIPRNET through its integrated satellite VSAT.

Deployable base stations can provide wireless data support to CDMA enabled data devices with CDMA2000 (1xRTT and EV/DO Rev A) or any other broadband wireless capabilities when those revisions are available as an option under this task order, based on costs and deliverables to be agreed by the parties.

Deployable base stations utilize a unique System ID (SID) which uniquely identifies the deployable base station and distinguishes it from commercial cellular networks, thereby limiting access to the system to only approved users and devices. This limits network demand, thereby ensuring the network is available to those who need it (e.g., first responders and government personnel). Approved users may be provided with cellular devices (e.g., cell phones and notebook cellular network access cards) programmed with the unique SIDs of deployable base stations. Also or alternatively, authorized network users may have their personal cellular devices programmed to include the unique SIDs in order to grant them access to the deployable base stations.

Deployable base station can also provide land mobile radio (LMR) radio bridges. In this mode, the deployable base station can enable users with LMRs to place calls to and receive calls from cellular and PSTN telephones, as well as connect to other LMRs communicating via other deployable base stations. Deployable base stations can also have the ability to provide one-to-one and one-to-many push-to-talk (PTT) services to wireless users and quality of service (QOS) capabilities with EV/DO Rev A upgrades.

Deployable base stations may include Signalling Transfer Point (STP) and Home Location Registry (HLR) service software and data bases that allow for the authentication of a variety of mobile handset subscribers, including commercial and military systems.

Deployable base stations may include network and systems management software and work in conjunction with centrally located teleport switching and Home Location Registry (HLR) systems to maintain the call hand-off, or roaming, capabilities.

Referring to FIG. 1, systems employing deployable base stations may be configured with a variety of components and systems. In an embodiment, a deployable base station 10a includes a cell-based station 8a, LMR Radio Bridging equipment (part of 8a), 390 cell phones 1a, a gas or diesel generator (not shown), and self-acquiring KU band SATCOM terminal 9a. In another embodiment, the deployable base station includes a cell-based station, LMR Radio Bridging equipment, 100 cell phones, a diesel generator, 25 aircards, 20 Laptops, and a self-acquiring KU band SATCOM terminal. In yet another embodiment, the system includes a cell-based station, LMR Radio Bridging equipment, 100 cell phones, a diesel generator, 25 aircards, 20 Laptops, and self-acquiring KU band SATCOM terminal.

In an embodiment, data received from computing devices, such as laptop computers 1a and handheld devices 3a may be transmitted as Internet protocol (IP) data packets via the satellite backhaul communication system, while voice data, such as received from cellular telephones 1a may be communicated as voice over IP (VOIP) data. By converting voice communications into VOIP format, telephone calls can easily be routed via the Internet and processed using standard Internet router equipment.

When deployed, multiple deployable base stations 10a, 10b can communicate via a communications satellite 20 to a remote ground station 22 coupled to a teleport 30. At a typical teleport, signals received by a ground station 22 may be processed by a satellite terminal 32, such as a Linkway™ satellite communication terminal, with the perceived IP data or VOIP data being crafted by a network router 34, such as a Cisco 3845 integrated services router. Received telephone calls destined for a public telephone connection may be routed to a global mobile satellite communication/media gateway processor 36 where the VOIP data is converted into standard telephone signal data for transmission via the public switched telephone network (PSTN) 50. From there, telephone calls may be routed to their destination and is an ordinary telephone call. Received telephone and data calls destined for a cellular telephone may be rounded via a network router, such as a Cisco 2851 integrated services router 38, the dedicated circuits 39, such as multiple T1 communication lines, or level 3 multiprotocol label switching IP backbone 52 to a level 3 router 45. The call may be routed using a home location registry (HLR) database 47 and a signal transfer point (STP) switch 49. Call traffic routing and coordination with deployed base stations 10a, 10b may also be controlled by a network management system/operational support services unit 41 which may be coupled to the level 3 router 45 via a firewall processor 43.

The various embodiments enable the establishment of a meshed network that eliminates double satellite hops between deployed base stations 10a, 10b and callers on other networks, such public switched telephone networks. Routing calls through such a meshed network reduces call latency (i.e., signal delays through the network) while reducing satellite bandwidth requirements.

As mentioned above, the deployable base stations 10a, 10b may be assigned a unique SID which is a code that cellular telephones use to recognize and communicate with cellular telephone networks. This assignment of unique SID codes to deployable base stations 10a, 10b can be used to limit network access to handsets and other wireless devices that are programmed to recognize the unique SID. Consequently, deployable base stations 10a, 10b can be configured to provide private communication networks for use by first responders, government personnel (federal, state and local), police, fire, ambulance and other emergency personnel.

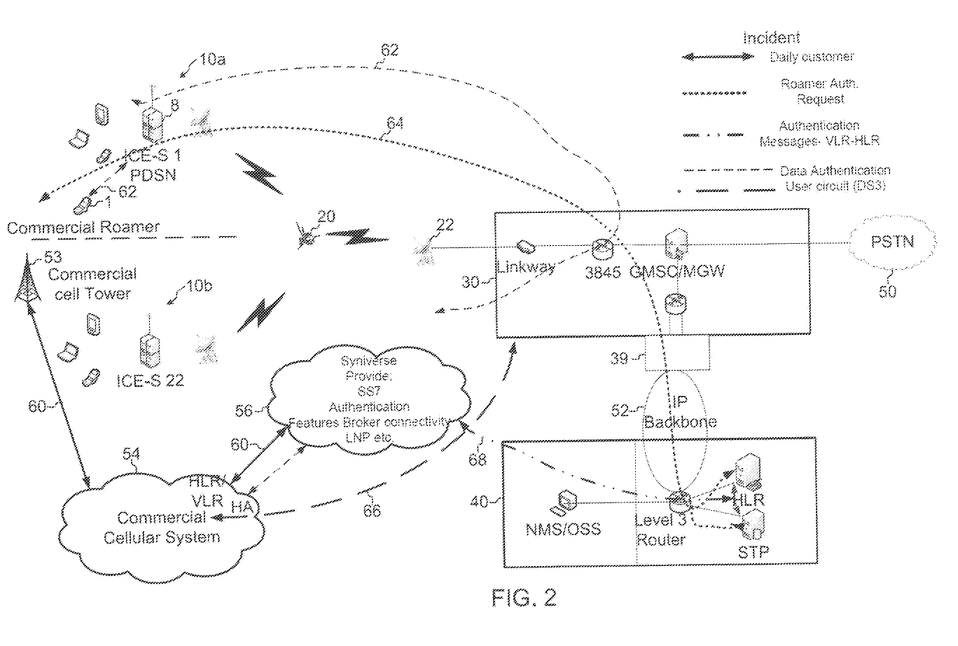

FIG. 2 illustrates some of the call routing and authentication processing that may be implemented in a typical cellular telephone call placed via a mobile base station 10a. In normal conditions when commercial cellular mutation capabilities are available, a cellular call may be received by a commercial cell tower 53 and rooted through normal communication line 62 the commercial cellular system 54. However, when commercial cellular base stations are not available, a cellular call from a cellular telephone 1 may be placed via a mobile base station 10a by communicating with the base station equipment 8. As part of such a call, a request for Roamer authentication 64 may be routed via the satellite communication link to a remote teleport 30 and through the network described above with reference to FIG. 1 to a processing center where the call may be authenticated using an HLR database and STP switch. Data calls may similarly be authenticated by routing the data communication 62 via the teleport 30 servers to a cinder verse network 56 which can provide authentication for SS7 communications. Once authenticated, communications may be routed to commercial cellular systems 54 by a user circuit 66 connected to the teleport 30 enabling interoperable roaming capabilities.

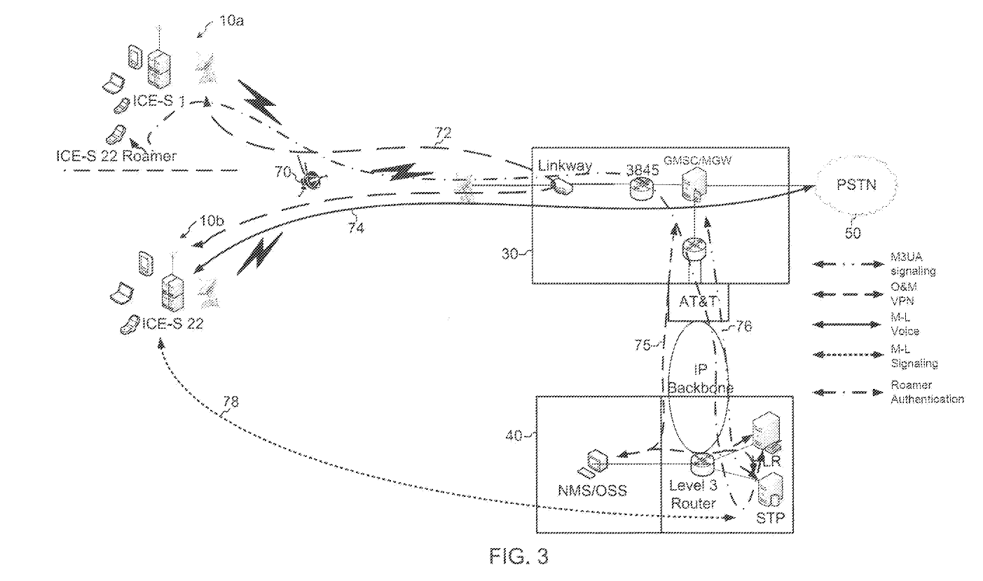

FIG. 3 illustrates some of the communication links that are available between deployable base stations 10a, 10b and supporting communication systems. As mentioned above with reference to FIG. 2, cellular telephone call rover authentication may be accomplished by communications between a cellular telephone, a deployable base station 10a, a satellite communication bridge to a teleport 30 and network communication to an HLR database and STP switch. Voice and data calls may be communicated from one deployable base station 10a to another 10b via a vacation satellite 79 transmitting the voice or data call to a teleport 30 where the call is routed back through the communications satellite 72, the other remote base station 10b, as indicated in dashed line 72. Telephone calls from cellular telephones using the ICE-S platforms to the public switched telephone network 50 may similarly be routed via the communications satellite 72 a teleport 30 and through the GMSC/MGW to the PSTN 50 enabling full cellular functionality.

To support efficient interoperability with public and private networks, a network operation center (NOC) may be provided that receives calls routed from the satellite linkway. Such a NOC, HLR and STP databases maintained to support the deployable base stations can be accessed to facilitate call routing through public or private networks as illustrated in FIG. 3.

Calls can be switched, routed and transported as Internet Protocol (IP) data packets, which facilitates management of communications in the system. Since the system employs IP data links, the system can also provide robust support to data communications within, as well as into/out of the deployable base station deployment area.

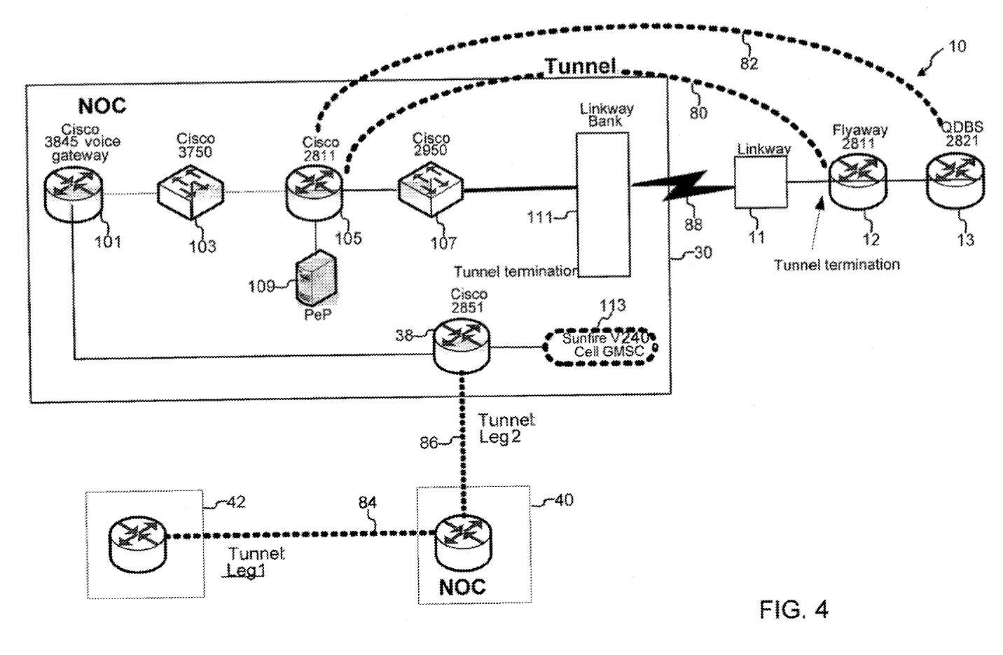

FIGS. 4-9 illustrate details of example system implementation embodiments. As shown in the figures, the interim communication extension system includes one or more deployable base stations 10a, 10b which include cellular communications systems and a router switch 8a, 8b and a satellite up/down link capability 9a, 9b. Such deployable base stations can be configured to receive and send cell phone calls using GSM, CDMA or future communication protocols. Calls can be routed through the included switch (a computer system (e.g., soft switch—IMS)) so that calls from one cell phone to another located within range of the deployable base station (or another deployable base station nearby) can be routed directly (i.e., without requiring access to a central switching center). Calls to destinations outside the range of the deployable base station can be routed via the switch to the satellite communication system to a satellite linkway 32 where they can be connected to public or private (e.g., military or government) networks.

FIG. 4 illustrates how a deployed base station 10 can provide a data communication to a distant operation center 30, 40 or distant user 42 via satellite communication links 88 even when commercial and military communication systems are unavailable. In the illustrated example, an effective communication tunnel 80 may be established between a communication router 105 in a national operation center (NOC) 30 and a router 12 in the deployed base station 10 via a satellite communication link 88. That communication link is established via a satellite 20 between a satellite transceiver 11 in the deployed base station 10 and one or more satellite transceivers in a bank of transceivers 111. The particular satellite transceiver carrying the tunnel 80 to a particular deployed base station 10 may be selected by a switch 107, such as a Cisco Model 2950 Switch. In a similar manner a communication tunnel 82 may be established between the router 104 in the NOC and a database router 13 within the deployed base station 10 to enable direct database-to-database communications via a satellite communication link. The NOC may also include a Performance Enhancing Proxy (PEP) 109 to accelerate TCP communication speeds. To make full use of the communication tunnels 80, 82, the NOC may also include an integrated services router 101 configured to process voice over IP communications and a switch 103 to enable voice calls to be transmitted to the deployed base station 10 using the communication tunnels 80, 82. Communications to nodes connected to the deployed base station 10 may be routed by an Internet router 38, such as a Cisco model 2851 integrated services router. Such a router may receive voice communications that have been converted into voice over IP format by a global mobile satellite communication receiver processor 113. Such a router may also receive data communications from other NOC's 40 or distant users or networks 42 via landline communication links 84, 86. In this configuration, the router 38 in the NOC routs communication from the distant networks 40, 42 to the deployed base Station 10 DM, the satellite communication tunnels 80, 82.

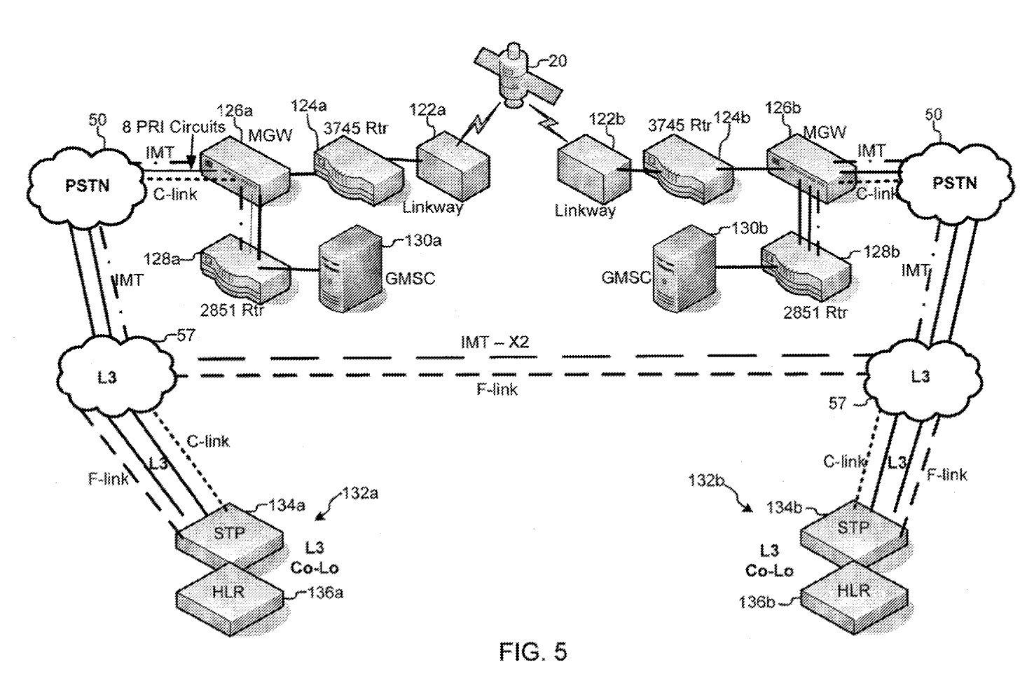

FIG. 5 illustrates example component switch that may be employed on both sides of a satellite communication link according to various embodiments. Such component may be deployed within a deployable base Station 10 or a satellite grounds station and NOC facility. Using the example embodiment illustrated in FIG. 5, wireless communications (e.g., International Mobile Telecommunications (IMT-X2) and data communications (e.g., SS7 F-links) can be established between two signal switching points 132a, 132b that cannot be linked by land lines by using communication links via a satellite 20. Communications from a first signal switching point 132a, which may include any home location registry (HLR) 136a and a signal transfer point (STP) 134a, may be transmitted via level 3 communications links 57 to the public switched one telephone network (PSTN) 50 where they connect to a satellite communication facility such as a NOC. Within the satellite communication facility, voice or data communications, including cellular voice communications, may be received by a media Gateway circuit 126a which is coupled to a router 124a, such as a Cisco model 3745 integrated services router, that is connected to a satellite transceiver 122a. Data communications then can be routed directly from the media Gateway circuit 126a via the router 124a to the satellite transceiver 122a for transmission via the satellite 20. Voice communications may be converted into voice over IP data format by ranking them, via a router 128, such as a Cisco model 2851 integrated services router, to a global mobile satellite communication system 130a. There the received signals are converted into voice-over IP data format and routed back through to the satellite transceiver 122a for transmission. Signals transmitted via the satellite 20 then can be received and processed using the same types of component and a reverse order. In other words, satellite transmissions may be received by a satellite transceiver 122b, granted by a network router 124b to a media gateway circuit 126b before being transmitted via the PSTN 52 the destination signal switching 132b. Received satellite signals including voice data may be processed in a global mobile satellite communication system 130b to return the signals into voice signals which can be appropriately carried by the PSTN 50.

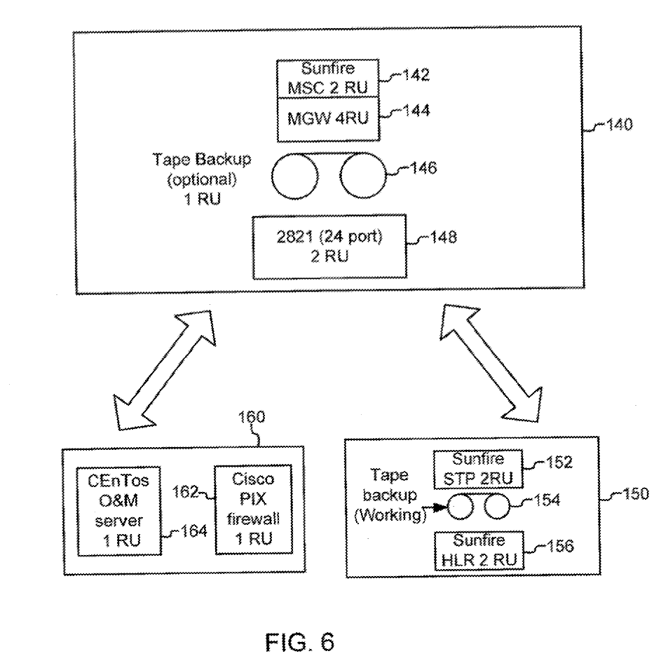

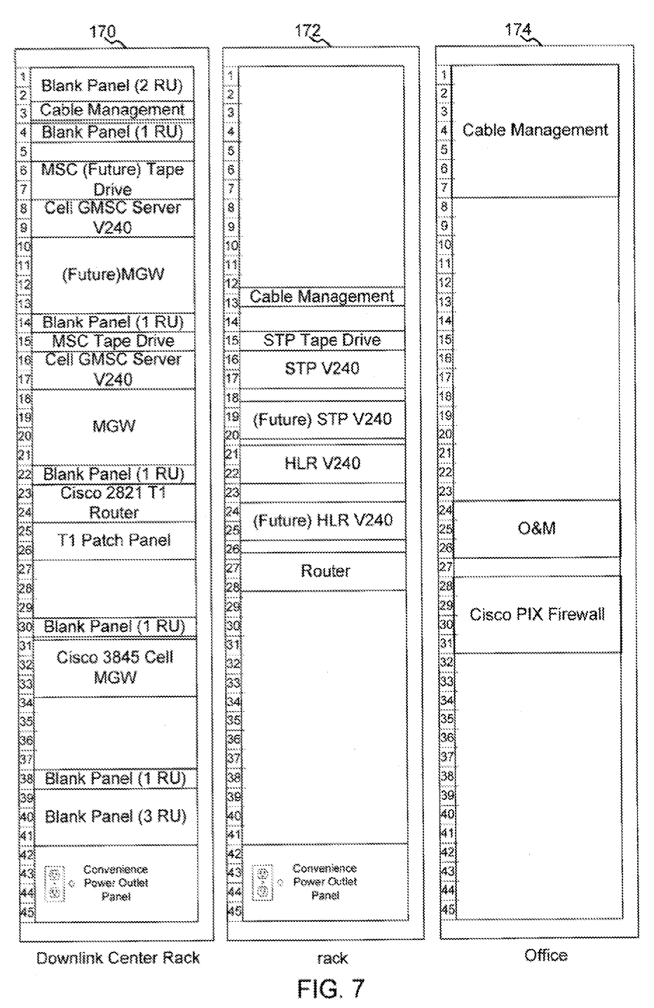

FIGS. 6 and 7 illustrate an embodiment configuration and components that may be included within a deployable base station and/or in a NOC configured to communication with deployable base stations. Components in a downlink center 140 may include one or more mobile switching centers (MSC) 142 coupled to one or more media gateway routers 144. A tape back up system 146 may be included along with an integrated services router 148. These components may communicate with a Level 3 communication system 150 including one or more signal transfer point (STP) units 152 and one or more home location registry (HLR) databases 156. These components may also communicate with an office network system 160, including a firewall system 162 and an operations and management (O&M) server 164. As illustrated in FIG. 7, these and other supporting components may be configured as rack units (RU) that may be integrated into three electronic rack units 170, 172, 174.

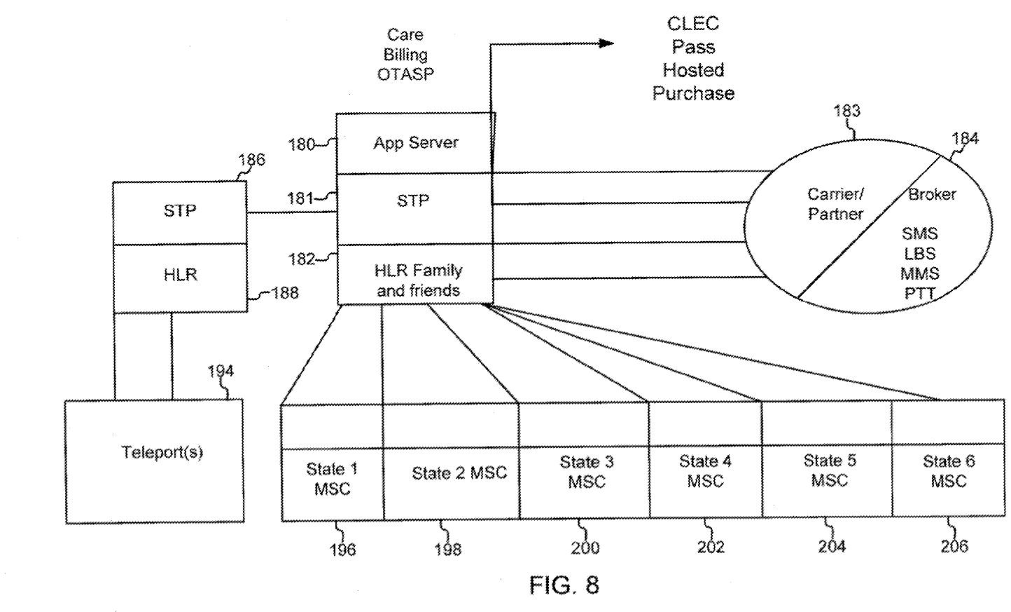

Communications between users via communication centers that communicate with mobile base stations 10 may utilize commercial telephone and cellular telephone carriers and partners. As illustrated in FIG. 8, communications to and from a deployed base station 10 (not shown in FIG. 8) may be received at a teleport 194 with calls validated and routed using a local home location registry (HLR) 188 and a signal transfer point (STP) 186. Received communications can be carried by commercial carriers 183 by a signal transfer point (STP) 181 coupled to the teleport STP 186 and the commercial carrier 183. At that point, over-the-air service provisioning (OTASP) may be provided to cellular telephones communicating via the deployed base station 10 by an application server 180. Communication plans and billing may also be coordinated with a home location registry (HLR) 182 that coordinates with a number of mobile switching centers (MSC) 196-206 in a variety of states. In this arrangement, commercial carriers can provide additional cellular related services, including simple message system (SMS) service, location based services (LBS), multimedia messaging Services (MMS) and push-to-talk (PTT) communications (collectively 184).

By providing replacement or augmentation cellular communications, the deployable bases stations allow emergency response teams to promptly set up effective communications infrastructure which is interoperable with users' standard handset communicators (e.g., cell phones). Additional transceiver capability can be included to enable responders to use other handsets, such as two-way radio, push-to-talk (PTT) handsets, and WiFi and WiMax links for mobile computers and PDAs. The deployable base stations' satellite backhaul communications capability enables national and global communications using existing infrastructure. Databases and software in a central location facilitates routing calls through commercial or private communication networks, such as commercial cell phone systems.

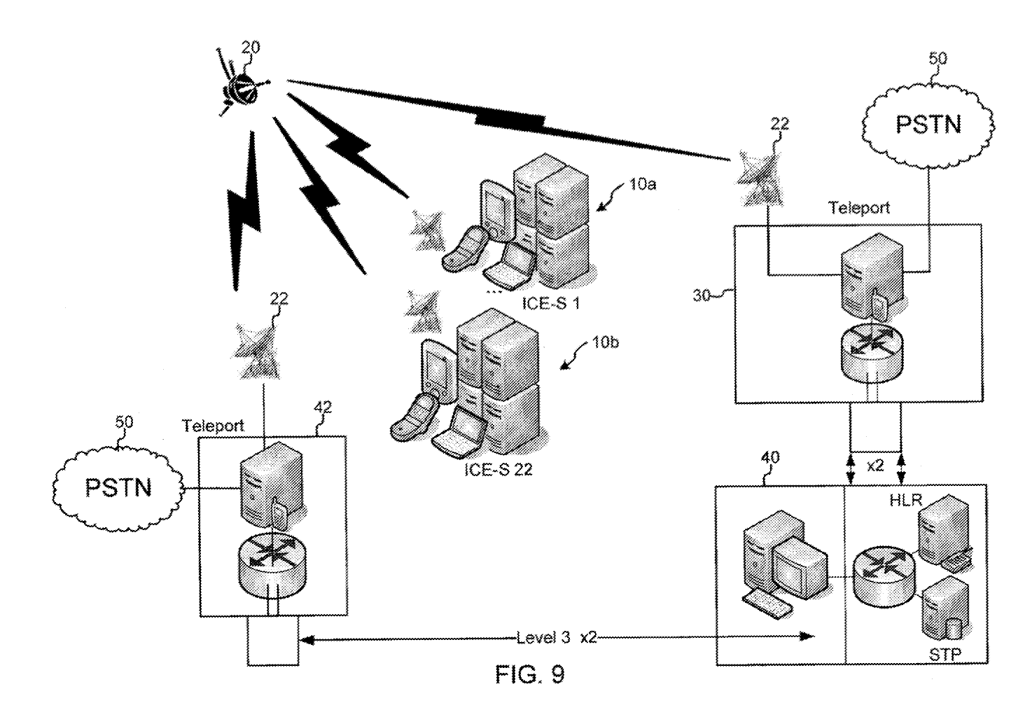

These communication capabilities are illustrated in FIG. 9. In the event of an emergency, a number of deployable base stations 10a, 10b may be positioned where cellular telephone services are no longer available. By providing local cellular base station capability, cellular telephone operators in the vicinity of the deployable base station 10a, 10b may communicate with each other via that local base station. Additionally, cellular telephone users may access the public switched telephone network 50 by transmitting voice communications in voice over IP format via a satellite 22 distant ground stations 22 as part of teleports 30, 42. Thus, telephone calls to or from individuals connected by the public switched telephone network 50 may be connected with individuals within the emergency area. Similarly, data communications, such as from deployed laptop computers 2a, 2b associated with deployable base stations 10a, 10b (e.g., by way of a local area network or by cellular wireless network), may be established with distant databases, networks and the Internet via satellite communications connecting to ground stations 22 in teleports 30, 42. These servers can route data communications to the appropriate and address. Teleports 30, 42 may also be connected with network operation centers 40 by private or public networks, thereby providing a robust communication capability accessible by users with emergency areas.

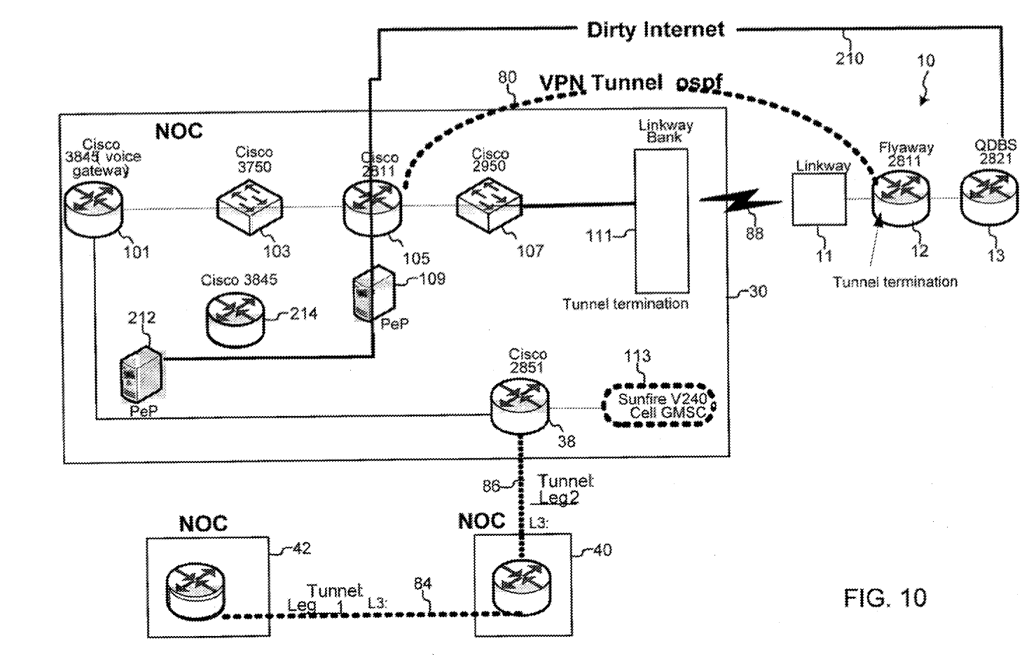

Example elements and implementation details of a preferred embodiment are described in the following paragraphs with reference to FIGS. 10-13. While the following embodiment description identifies suitable commercially available products for use in the various components it should be understood that the invention is not limited to identified products. Similarly, the following embodiment description identifies suitable communication protocols and interconnections, but it should be understood that the invention is not limited to the identified protocols and implementations.

In an embodiment illustrated in FIG. 10, deployable base stations 10 may employ a two-router communication system to carry the IP traffic made up of Voice and Internet data. The first router 12, a suitable example of which is a Cisco model 2811 integrated services router, is used with a satellite communication modem 11, a suitable example of which is a ViaSat Linkway, to connect to a distant network operations center 30. The first router 12 and satellite communication modem 11 form the communication path 88 to allow the IP traffic to traverse between the deployed base station unit 10 and the equipment at the network operations center 30. The communications uses the open shortest path first (OSPF) routing protocol to recognize new systems as they attach to the network operations center 30. The embodiment may implement an Internet protocol security (IPSEC) virtual private network (VPN) tunnel 80 to encrypt data traffic across the satellite links 88. The IPSEC tunnel 80 may use the AES encryption algorithm to secure the IP traffic. For the OSPF routing protocol to work there is a generic routing encapsulation (GRE) tunnel setup between the deployed base station unit 10 and network operations center 30. On this tunnel rides the OSPF routing protocol carried through the IPSEC VPN tunnel 80.

The second router 13 used in the deployed base station unit 10 may also be a Cisco router, model 2821. This second router 13 supports the deployed base station unit 10 which houses the cellular phone system as well as the aircards used for laptop computer connectivity. This router 13 may also use four FXS ports to connect analog phones, a land mobile radio interoperability system, such as a Raytheon Corp. ACU 1000 LMR interoperability system, and/or fax machines to the deployed base station unit 10. The second router 13 supports voice traffic communication as well as Internet data traffic. Each of these types of communication traffic is separated from the other by the use of virtual local area networks (VLANs).

Voice traffic may be connected into this router 13 by the use of T-1 PRI ports that are connected to MSC/Gateway or the FXS ports installed in VWIC slots on the router 13. Voice traffic is converted into VOIP packets that are then transmitted to any distant network location via the satellite communications link 88 where the VOIP packets may be passed to a GMSC/Gateway 101 which then routes the voice traffic out to the PSTN network. This same path carries the voice traffic from the PSTN network out to each deployable base station unit 10 on the network.

Data traffic follows a similar path except once it arrives at the network operations center 30 the data traffic is diverted out to Internet routers that are separate from the voice traffic routers in the facility. The data traffic is encrypted from the time it leaves the 2821 router 12 until the traffic arrives on the Internet router 105 at the network operations center. At that point the data traffic may be unencrypted and routed out onto a network to its final destination. Data traffic transmitted via satellite communications links 88 maybe encrypted in an IPSEC VPN tunnel 80 also using the AES encryption algorithm.

In the data traffic path is one or more TCP accelerators called an PEP 109, 212 (Performance Enhancing Proxies) or X-PEP. An example of a suitable PEP 109, 212 is made by ViaSat, Inc. An X-PEP 109, 212 may be provided in each deployable base station unit 10 as well as one at that court operations center. The purpose of the X-PEP 109, 212 is to speed up the flow of TCP traffic between the source and destination when such traffic travels across satellite transmission lines.

LMR Implementation: Land Mobile Radio (LMR) Systems denote a wireless communications systems, such as systems used by emergency first responder organizations, public works organizations, or companies with large vehicle fleets or numerous field staff. Such systems can be independent, but often can be connected to other fixed systems, such as the public switched telephone network (PSTN) or cellular networks. Such systems are also called Public Land Mobile Radio or Private Land Mobile Radio. In an embodiment, deployable base station units 10 may include one or more communication interoperability gateways, such as a Raytheon ACU-1000 LMR system. Such systems, which are referred to herein as a communication interoperability circuit, allows a telephone (be it land line or cellular) to talk to a LMR radio and vice versa. Typical LMR talk groups can be supported for both LMR radios and cell phone users.

SATCOM Implementation: in an embodiment, deployable base station units 10 can provide broadband network-centric SATCOM to any location in less than ten minutes using commercially available satellite communications terminals, such as the ViaSat, Inc. IP SATCOM Flyaway Terminal. The Flyaway satellite communication terminal delivers deployable, two-way, secure IP communications over existing Ku band transponders, allowing users to work wirelessly and securely from any location in the Theater of Operations or emergency response area.

Example methods and processes for setting up and using the ICE-S are described in the following paragraphs.

Mobile Cellular Implementation: During a contingency event a number of possible government agencies may request deployable base station units 10 to provide cellular frequency spectrum service for an area. In doing so, the operator of deployable base station units 10 may coordinate the spectrum usage while the system equipment was deployed locally. From that point, the communication equipment can be set up using commercial power or self-contained generators. The portable satellite dish can be setup so that it acquires a communication satellite.

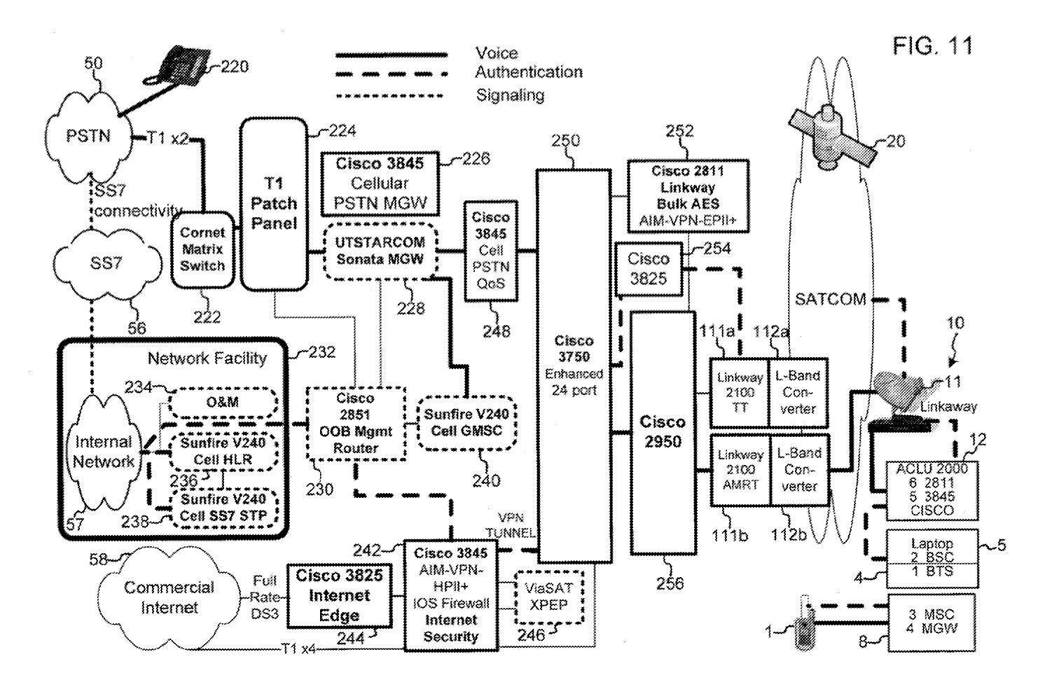

Once the system is brought up, a mobile phone would then register on the system. Signalling paths for authentication signalling and voice communications are illustrated in FIG. 11.

Authentication: When a mobile phone 1 powers up it will first go through the BTS 4 (Base station Transceiver Subsystem) and then connect to the BSC 5 (Base Station Controller). The BSC 5 device controls all the BTSs 4 and connects to the MSC 8 (Mobile Switching Center). In this case, a message would be sent to the MGW (Media Gateway Controller). The messaging is converted into IP packets and use SIGTRAN, SCCP, and MU3A signalling to attempt to authenticate the mobile device 1. From the MGW 8 the voice communication packets would route through a Cisco 3845 and 2811 transec router 12. The transec router 12 is connected to the ViaSAT Linkway satellite transponder 11 which transmits the voice communication packets to the specified satellite 20 and for relay to a distant teleport.

Upon arriving at the teleport, the voice communication packets go through an L-band converter 112a, 112b and another ViaSAT Linkway satellite transponder 111a, 111b and through another Cisco 3825 router 254 and a switch 250, such as a Cisco model 3750. In a secure installation, this connection may be restricted with only a physical connection to connect to a VPN tunnel through a Cisco 3845 firewall router 242. The voice communication packets then pass on the SIGTRAN signalling to an “out of band” Cisco 2851 router 230. From there the voice communication packets are routed to a STP 238 (Signal Transfer Point) and HLR database 236 (Home Location Register) in a network operations center 232 (NOC) for authentication. This process then validates the mobile subscriber using the cellular telephone 1 and allows the person to place a cellular call. In a similar manner a data call may be authenticated to enable a user to perform a data function on a cellular phone or on a laptop computer using an aircard.

Call Setup: For a call setup, the control signal will follow the same path as above but once it arrives at the STP238 in the NOC 232, it will route to a SS7 network via a STP 56 to look ahead to route and see if a connection with the far end is available to establish a commercial call. This all happens under the following protocols: SIGTRAN, SCTP, MU3A, and SIP. If available the call will setup and establish the voice path mentioned below.

Voice Path Implementation: Once the SS7 communication setup is established, a call will utilize its voice path may use the protocols SIGTRAN/SCCP, M3UA and IS41. The voice communication path would go from the cellular telephone 1 through BTS 4, to the BSC 5 and then to the MGW 8. From the MGW 8 it would route to the local router 12, such as a Cisco 3845, where voice signals are converted into VOIP packets. From there VOIP packets would go to the Cisco 2811 Transec router 12 and then to the ViaSAT Linkway satellite transponder 11. The VOIP packets would then be transmitted to the satellite 20 and back down to a teleport facility. Upon arrival at the teleport facility the VOIP packets go through a ViaSAT Linkway satellite transponder 111a, 111b and another Cisco 2811 Transec router 254. The VoIP packets then go to a CISCO 3845 Router 248 and then on to an MGW 228 where the VOIP packets are converted back into the pulse code modulation of a regular phone call. From there the voice signal can be connected to the Public Switched telephone Network (PSTN) 50 via a primary rate interface circuit connecting to a Local Exchange Carrier to enable the voice to be heard for the cellular telephone 1 at telephone 220 connected to a land line.

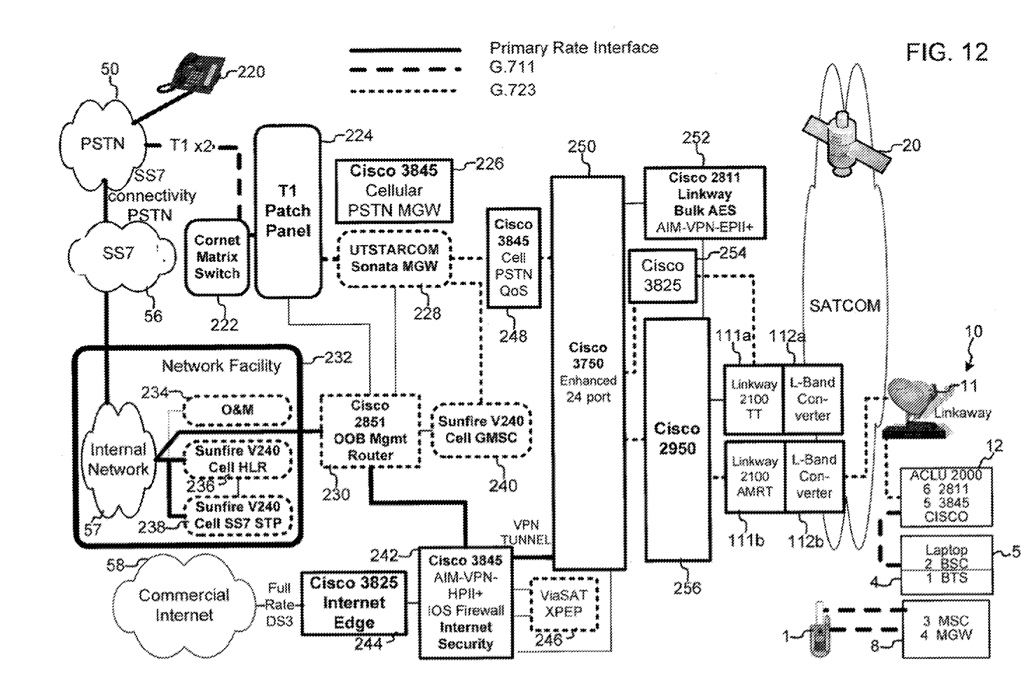

FIG. 12 illustrates how communication signals may be compressed using G.711 and G.723 compression protocols. Communications between a cellular telephone 1 and a deployable base station unit 10 may use G.711 compression, while communications with the satellite terminal 11, the satellite and within a teleport may use G.723 compression. Eventually signals may be decompressed to the primary data rate for communication via the PSTN 50.

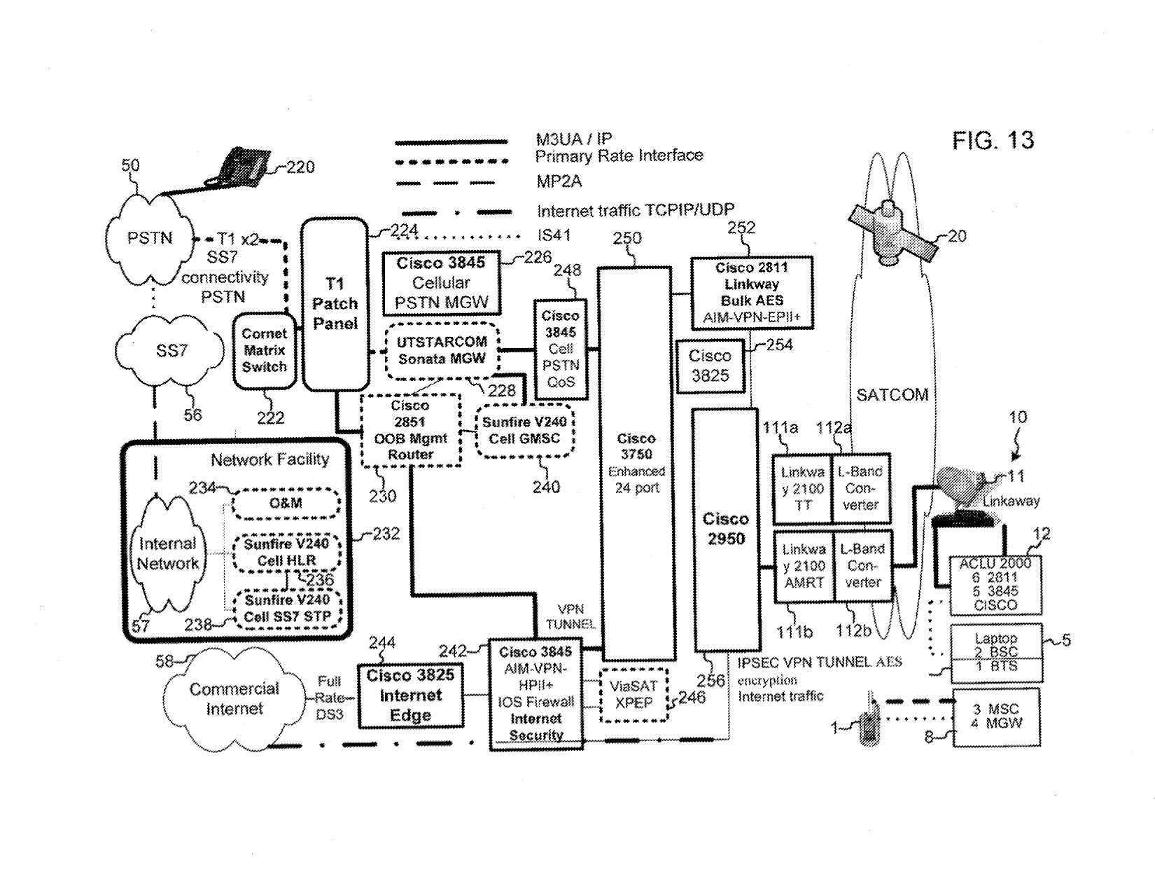

A variety of data communication protocols may be implemented within the communication links involved between a land line telephone 220 and a cellular telephone 1 communicating via a deployed base station unit 10. Examples of how various communication protocols may be implemented are illustrated in FIG. 13. The following paragraphs provide background information on communication protocols and configurations that may be utilized in the various embodiments.

IPSec Implementation: IPSec protocol operates at the network layer, or layer 3 of the OSI model. In contrast, other Internet security protocols in widespread use, such as SSL, TLS, and SSH, operate from the transport layer up (OSI layers 4-7). This makes IPSec more flexible, as it can be used for protecting layer 4 protocols, including both TCP and UDP, the most commonly used transport layer protocols. IPSec has an advantage over SSL and other methods that operate at higher layers. For an application to use IPSec, no code change in applications is required, whereas to use SSL and other higher level protocols, applications must undergo code changes. IPSec is implemented by a set of cryptographic protocols for (1) securing packet flows, (2) mutual authentication, and (3) establishing cryptographic parameters.

OSPF Implementation: The Open Shortest Path First (OSPF) protocol is a hierarchical interior gateway protocol (IGP) for routing in Internet Protocol, using a link-state in the individual areas that make up the hierarchy. OSPF is perhaps the most widely-used IGP in large enterprise networks. The OSPF Protocol can operate securely. OSPF does not use TCP or UDP but uses IP directly.

X-PEP Implementation: Performance Enhancing Proxies (PEPs) are network agents designed to improve the end-to-end performance of communications protocols, such as Transmission Control Protocol (TCP). PEPs function by breaking the end-to-end connection into multiple connections and using different parameters to transfer data across the different legs. This allows the end systems to run unmodified and can overcome some problems with TCP window sizes on the end systems being set too low for satellite communications. An embodiment system makes extensive use of PEP technology to provide enhanced data services to end user devices.

SIGTRAN Implementation: The Signal Transport (SIGTRAN) protocol is the name given to an Internet Engineering Task Force (IETF) working group that produced specifications for a family of protocols that provide reliable datagram service and user layer adaptations for SS7 and Integrated Services Digital Network (ISDN) communications protocols. The most significant protocol defined by the SIGTRAN group was the Stream Control Transmission Protocol (SCTP), which is used to carry PSTN signalling over IP.

The SIGTRAN group was significantly influenced by telecommunications engineer's intent on using the new protocols for adapting VoIP networks to the PSTN with special regard to signalling applications. Recently, SCTP is finding applications beyond its original purpose wherever reliable datagram service is desired. The SIGTRAN family of protocols includes:
ISDN User Adaptation (IUA);
MTP2 User Peer-to-Peer Adaptation Layer (M2PA);
MTP2 User Adaptation Layer (M2UA);
MTP3 User Adaptation Layer (M3UA);
Stream Control Transmission Protocol (SCTP);
SCCP User Adaptation (SUA); and
V5 User Adaptation (V5UA).

An embodiment tailors typical commercial implementations using SIGTRAN on the deployable base station and connected networks.

M3UA Implementation: The M3UA provides the signalling required for call set up and control. The M2PA provides the peer to peer IP link communication for voice communication. By using Signalling Gateways (SG) and Media Gateway (MGW) Controllers this allows for convergence of some signalling and data networks. SCN signalling nodes can access databases and other devices in the IP network domain that do not use SS7 signalling links. Likewise, IP telephony applications can access SS7 services. There are also operational cost and performance advantages when traditional signalling links are replaced by IP network “connections.” The IP Signalling Points (IPSPs) function as traditional SS7 nodes using the IP network instead of SS7 links.

M2PA Implementation: M2PA (MTP2-User Peer-to-Peer Adaptation Layer) protocol supports the transport of Signalling System Number 7 (SS7) Message Transfer Part (MTP) Level 3 signalling messages over Internet Protocol (IP) using the services of the Stream Control Transmission Protocol (SCTP/SCCP)).

There is a need for Switched Circuit Network (SCN) signalling protocol delivery over an IP network. This includes message transfer between a Signalling Gateway (SG) and a Media Gateway Controller (MGC); between a SG and an IP Signalling Point (IPSP), and between an IPSP and an IPSP. This could allow for convergence of some signalling and data networks. SCN signalling nodes can access databases and other devices in the IP network domain that do not use SS7 signalling links. Likewise, IP telephony applications can access SS7 services. There are operational cost and performance advantages when traditional signalling links are replaced by IP network “connections”.

The delivery mechanism described herein allows for full MTP3 message handling and network management capabilities between any two SS7 nodes communicating over an IP network. An SS7 node equipped with an IP network connection is called an IP Signalling Point (IPSP). The IPSPs function as traditional SS7 nodes using the IP network instead of SS7 links. The delivery mechanism supports: seamless operation of MTP3 protocol peers over an IP network connection; the MTP Level 2/MTP Level 3 interface boundary; management of SCTP transport associations and traffic instead of MTP2 Links; and asynchronous reporting of status changes to management.

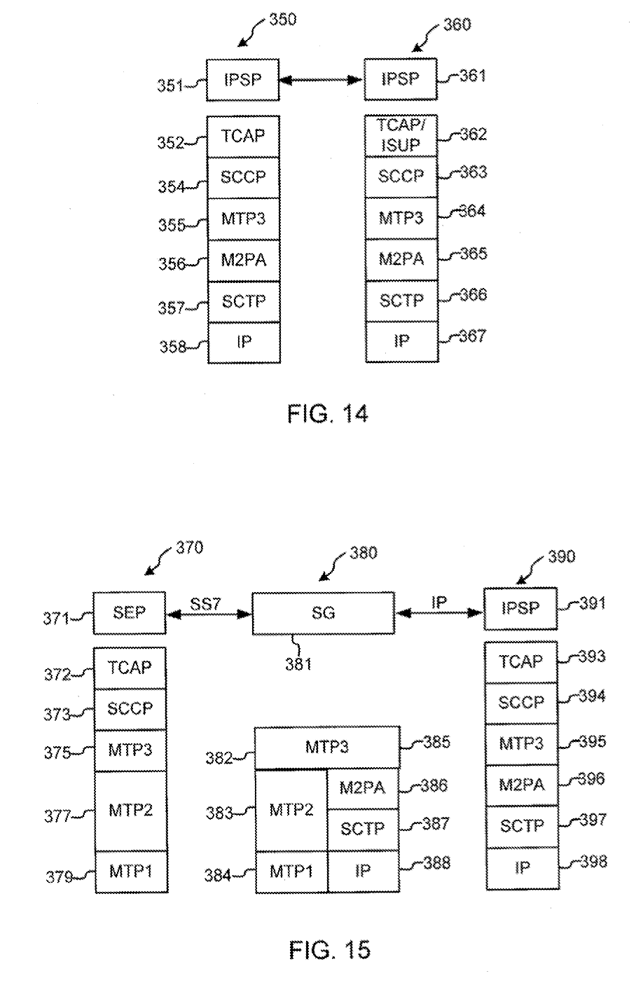

FIG. 14 shows the seamless interworking at the MTP3 layer. In this figure:
IPSP=IP Signalling Point;
TCAP=Transaction Capabilities Application Part;
SCCP=Signalling Connection Control Part, which allows routing using a Point Code and Subsystem Number or a Global Title;
MTP3=Message Transfer Part Level 3 which provides message routing between signalling points in the SS7 network. MTP3 re-routes traffic away from failed links and signalling points and controls traffic when congestion occurs;
M2PA=MTP2-User Peer-to-Peer Adaptation Layer; and
SCTP=Stream Control Transmission Protocol.

Referring to FIG. 14, an IP packet is transmitted from one location 350 to another 360 by being generated by an IP layer 358 and processed by the SCTP 357 which passes the processed packets to the M2PA 356 for adaptation before the data is passed to the MTP3 355 for routing processing. Packets are then processed by the SCCP 354 and TCAP 352 prior to being transmitted by the IPSP 351. Packets received at the destination are then processed by similar layers 361-367 in a reverse fashion. Further information regarding this communication stack arrangement can be found in Request for Comment (RFC) 4165 “SS7 MTP2-User Peer-to-Peer Adaptation Layer” dated September 2005.

FIG. 15 shows an example of an M2PA used in a Signalling Gateway (SG) 380. The SG 380 is an IPSP that is equipped with both traditional SS7 and IP network connections. This enables the SG 380 to act as a translator or interlocutor between a first party 370 on an SS7 network and a second party 390 on an IP network. The SG 380 and the IPSP communicate through an IP link using the M2PA protocol. Messages sent from the Signalling End Point (SEP) 371 to the IPSP 390 (and vice versa) are routed by the SG 380. Any of the nodes in the diagram could have SCCP or other SS7 layers above the MTP3 layer 375, 395. The Signalling Gateway 380 acts as a Signal Transfer Point (STP). Other STPs may be present in the SS7 path between the SEP 371 and the SG 380. FIG. 15 is only one example, and other configurations are possible. In short, M2PA 377, 386, 396 uses the SCTP 373, 387, 397 association as an SS7 link. The M2PA/SCTP/IP stack can be used in place of an MTP2/MTP1 stack. M2PA provides MTP2 functionality that is not provided by SCTP; thus, together M2PA and SCTP provide functionality similar to that of MTP2. SCTP provides reliable, sequenced delivery of messages. Further information regarding this communication architecture details can be found in RFC 4165.

M2PA functionality includes: data retrieval to support the MTP3 changeover procedure; reporting of link status changes to MTP3; processor outage procedure; and link alignment procedure. M2PA allows MTP3 to perform all of its Message Handling and Network Management functions with IPSPs as it does with other SS7 nodes.

Differences between M2PA and M2UA: The MTP2 User Adaptation Layer (M2UA) also adapts the MTP3 layer to the SCTP/IP stack. This section is intended to clarify some of the differences between the M2PA and M2UA approaches.

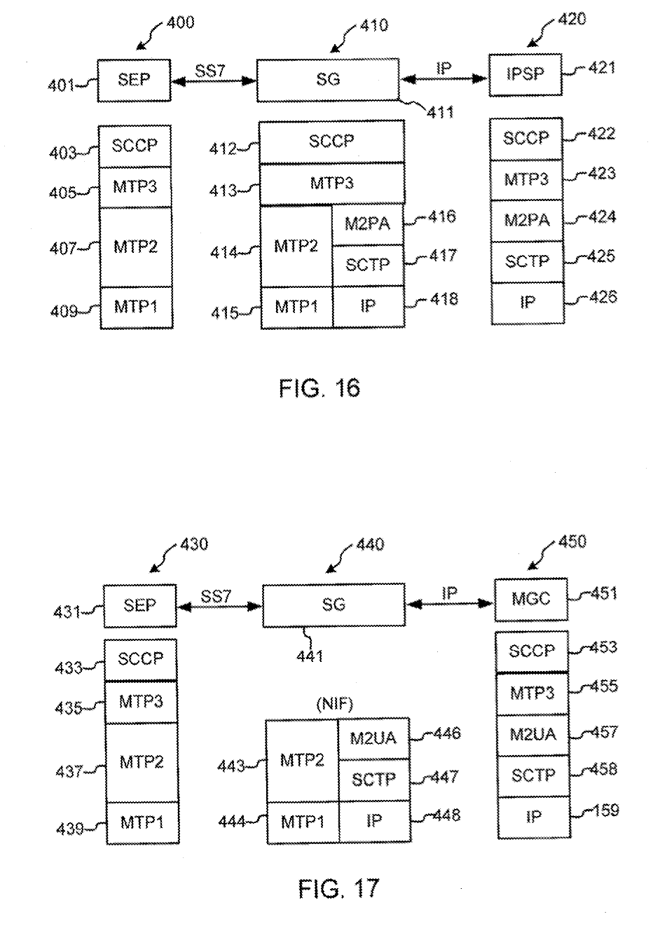

A possible M2PA architecture is shown in FIG. 16 which shows a M2PA 416 in an IP Signalling Gateway 410. In this architecture the IPSP's MTP3 423 uses its underlying M2PA 424 as a replacement for a MTP2. Communication between the two layers MTP3/M2PA 423, 424 and 413, 416 is defined by the same primitives as in SS7 MTP3/MTP2 405, 407. The M2PA 416, 423 performs functions similar to MTP2 414, 407.

A comparable architecture for M2UA is shown in FIG. 17 which shows a M2UA in an IP Signalling Gateway 441 which includes a Nodal Interworking Function (NIF). In this architecture for the M2UA, the MTP3 455 within the MGC 451 uses the SG's MTP2 443 within the SG 441 as its lower SS7 layer. Likewise, the SG's MTP2 443 uses the MGC's MTP3 455 as its upper SS7 layer. In SS7, communication between the MTP3 455 and MTP2 443 layers is defined by primitives. In M2UA, the MTP3/MTP2 communication is defined as M2UA messages and sent over the IP connection.

The M2PA and M2UA are similar in that both transport MTP3 data messages, and both present an MTP2 upper interface to MTP3. There are a number of differences between the M2PA and M2UA. For one, in a M2PA the IPSP processes MTP3/MTP2 primitives, while in a M2UA the MGC transports MTP3/MTP2 primitives between the SG's MTP2 and the MGC's MTP3 (via the NIF) for processing. For another, in a M2PA the SG-IPSP connection is an SS7 link, while in a M2UA the SG-MGC connection is not an SS7 link. It is an extension of MTP to a remote entity. For another, in a M2PA the SG is an SS7 node with a point code, while in a M2UA the SG is not an SS7 node and has no point code. For another, in a M2PA the SG can have upper SS7 layers, e.g., SCCP, while in a M2UA the SG does not have upper SS7 layers since it has no MTP3. For another, a M2PA relies on a MTP3 for management procedures, while a M2UA uses M2UA management procedures. Potential users of M2PA and M2UA should be aware of these differences when deciding how to use them for SS7 signalling transport over IP networks.

Since SCTP provides reliable delivery and ordered delivery, M2PA does not perform retransmissions. This eliminates the need for the forward and backward indicator bits in MTP2 signal units. Further information regarding this communication architecture details can be found in RFC 4165.

M3UA Implementation: M3UA supports the transport of any SS7 MTP3-User signalling (such as ISDN User Part (ISUP) and SCCP messages) over IP, using the services of the Stream Control Transmission Protocol (SCTP). The protocol is used for communication between a Signalling Gateway (SG) and a Media Gateway Controller (MGC) or IP-resident database. It is assumed that the SG receives SS7 signalling over a standard SS7 interface using the SS7 Message Transfer Part (MTP) to provide transport.

A MTP3-User is any protocol normally using the services of the SS7 MTP3 (e.g., ISUP, SCCP, TUP, etc.). The Network Appearance is a M3UA local reference shared by SG and AS (typically an integer) that, together with an Signalling Point Code, uniquely identifies an SS7 node by indicating the specific SS7 network to which it belongs. It can be used to distinguish between signalling traffic associated with different networks being sent between the SG and the ASP over a common SCTP association. An example scenario is where an SG appears as an element in multiple separate national SS7 networks and the same Signalling Point Code value may be reused in different networks.

A Signalling End Point (SEP) is a node in the SS7 network associated with an originating or terminating local exchange (switch) or a gateway exchange.

A Signalling Gateway (SG) is a signalling agent that receives/sends SCN native signalling at the edge of the IP network. An SG appears to the SS7 network as an SS7 Signalling Point. An SG contains a set of one or more unique Signalling Gateway Processes (SGP), of which one or more is normally actively processing traffic. Where an SG contains more than one SGP, the SG is a logical entity, and the contained SGPs are assumed to be coordinated into a single management view to the SS7 network and to the supported Application Servers.

At the SGP, the M3UA layer provides interworking with MTP3 management functions to support seamless operation of the user SCN signalling applications in the SS7 and IP domains. This includes: providing an indication to MTP3-Users at an Application Service Provider (ASP) that a destination in the SS7 network is not reachable; providing an indication to MTP3-Users at an ASP that a destination in the SS7 network is now reachable; providing an indication to MTP3-Users at an ASP that messages to a destination in the SS7 network are experiencing SS7 congestion; providing an indication to the M3UA layer at an ASP that the routes to a destination in the SS7 network are restricted; and providing an indication to MTP3-Users at an ASP that a MTP3-User peer is unavailable.

From an SS7 perspective, it is expected that the Signalling Gateway transmits and receives SS7 Message Signalling Units (MSUs) over a standard SS7 network interface, using the SS7 Message Transfer Part. It is also possible for IP-based interfaces to be present, using the services of the MTP2-User Adaptation Layer (M2UA) or M2PA. Further information about elements of this architecture is provided in the RFC 4666 “SS7 MTP3-User Adaptation Layer” dated September 2006.

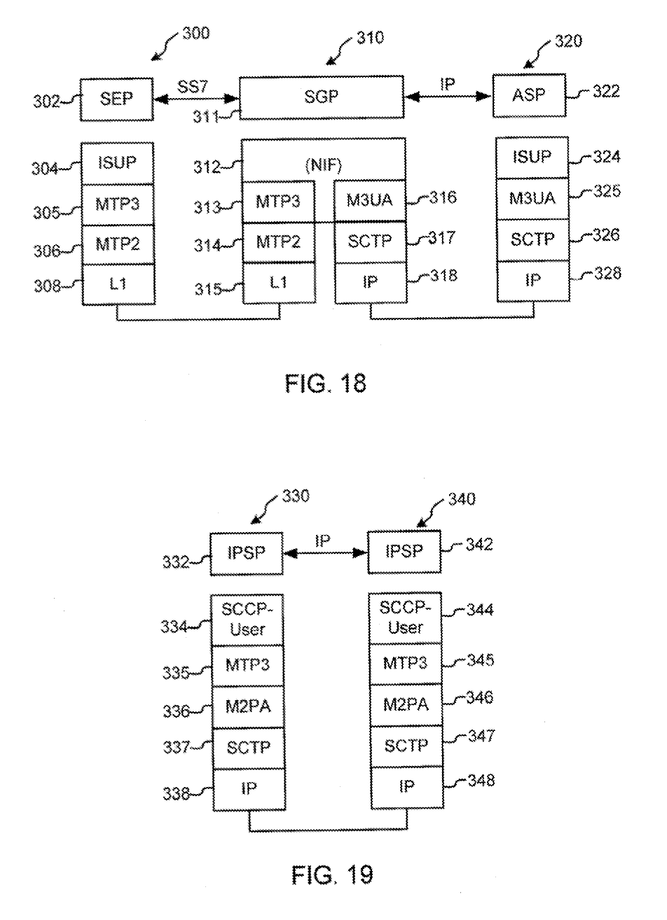

SCTP stream mapping is illustrated in FIGS. 18 and 19. FIG. 18 illustrates a first example of ISUP message transport. In this example, the SGP 310 provides an implementation-dependent nodal interworking function (NIF) 312 that allows the MGC 320 to exchange SS7 signalling messages with the SS7-based SEP 302. The NIF 312 within the SGP 311 serves as the interface within the SGP 311 between the MTP3 305 and M3UA 325. This nodal interworking function has no visible peer protocol with either the MGC 320 or SEP 302. It also provides network status information to one or both sides of the network. Further information about elements of this architecture is provided in the RFC 4666.

FIG. 19 illustrates a second example of SCCP Transport between IPSPs 332, 342. This example shows an architecture where no Signalling Gateway is used. In this example, SCCP messages are exchanged directly between two IP-resident IPSPs 332, 342 with resident SCCP-User protocol 334, 344 instances, such as RANAP or TCAP. SS7 network interworking is not required; therefore, there is no MTP3 network management status information for the SCCP and SCCP-User protocols to consider.

SIP Implementation: The Session Initiation Protocol (SIP) defines the INVITE method or the initiation and modification of sessions this allows a mapping between the Session Initiation Protocol (SIP) and the ISDN User Part (ISUP) of SS7 and is used for signalling to set up calls. An embodiment system uses both G.711 compression for the PCM portion until it converts over to Voice over IP packets as G.723 compression.

G.723 Implementation: G.723 compression is an ITU-T standard wideband speech codec. G.723.1 is mostly used in VoIP applications due to its low bandwidth requirement. Music or tones such as DTMF or fax tones cannot be transported reliably with this codec, and thus some other method such as G.711 or out-of-band methods should be used to transport these signals. CCITT defines a Channel Associated Signalling (CAS) scheme in G.732. In this mode of operation, using A-Bit signalling, the B, C, and D-Bits are set to a fixed state of 1, 0, and 1, respectively (BCD=101). If AB-Bit signalling is employed, the C and D-Bits are fixed at 0 and 1, respectively. Further information on G.723 compression is available in ITU-T Recommendation G.723.

G.711 Implementation: G.711 compression is an ITU-T standard for audio compounding. It is primarily used in telephony. G.711 represents logarithmic pulse-code modulation (PCM) samples for signals of voice frequencies, sampled at the rate of 8000 samples/second. There are two main algorithms defined in the standard, the μ-law algorithm (used in North America & Japan) and the A-law algorithm (used in Europe and the rest of the world). Both are logarithmic algorithms, but A-law was specifically designed to be simpler for a computer to process. The standard also defines a sequence of repeating code values which defines the power level of 0 dB. The μ-law and A-law algorithms encode 14-bit and 13-bit signed linear PCM samples, respectively, to logarithmic 8-bit samples. Thus, the G.711 encoder will create a 64 kbit/s bit stream for a signal sampled at 8 kHz. Further information on G.711 compression is available in ITU-T Recommendation G.711.

SS7 Network Implementation: SS7 networks provides technology interoperability, network services, number portability, and SS7 broker solutions to mobile operators.

The preferred embodiment described above is notable for a number of unique capabilities and features. These include that the system solution is Joint Interoperability Test Center (JITC) certified allowing the ability to roam externally with other cellular networks over commercial and/or government networks. This ability is brokered as an SS7 intermediary to cellular carriers providing ubiquitous network coverage in the event of a disaster. The embodiments use a unique combination of IP protocols, like MU3A and M2PA, to setup, connect, and communicate its signalling, voice, and data paths. The protocols include GRE, IPSEC, OSPF, SIGTRAN, IPv4 and IPv6.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A deployable cellular base station, comprising:
a cellular telecommunication transceiver;
an antenna coupled to the cellular telecommunication transceiver;
a first router coupled to the cellular telecommunication transceiver and configured to convert voice communications into voice-over-IP data packets; and
a communication satellite terminal coupled to the first router; and
a second router coupled to the communication satellite modem and configured to implement a virtual private network via a satellite communication link established by the communication satellite terminal.

2. The deployable cellular base station of claim 1, further comprising a land mobile radio communication interoperability circuit coupled to the first router.

3. The deployable cellular base station of claim 1, wherein the second router is configured to employ GRE, IPSEC, OSPF, SIGTRAN, IPv4, and IPv6 protocols.

4. The deployable cellular base station of claim 1, wherein the cellular telecommunication transceiver is configured with a system identifier (SID) which distinguishes the deployable base station from commercial cellular networks thereby limiting access to the cellular telecommunication transceiver to cellular communication devices programmed with the SID.

5. A communications system, comprising:
a teleport comprising:
a first communication satellite terminal;
a router coupled to the communication satellite terminal and configured to convert voice-over IP data into pulse code modulation format suitable for transmission over a public switch telephone network;
a home location registry database;
a signal transfer point; and
a circuit for apply pulse code modulation format signals to the public switch telephone network; and
deployable cellular base station, comprising:
a cellular telecommunication transceiver;
an antenna coupled to the cellular telecommunication transceiver;
a first router coupled to the cellular telecommunication transceiver and configured to convert voice communications into voice-over-IP data packets; and
a second communication satellite terminal coupled to the first router and configured to establish a satellite communication link with the first communication satellite terminal; and
a second router coupled to the second communication satellite modem and configured to implement a virtual private network via a satellite communication link established by the communication satellite terminal.

6. The communications system of claim 5, wherein the deployable cellular base station further comprises a land mobile radio communication interoperability circuit coupled to the first router.

7. The communications system of claim 5, wherein the second router is configured to employ GRE, IPSEC, OSPF, SIGTRAN, IPv4, and IPv6 protocols.

8. The communications system of claim 5, wherein the cellular telecommunication transceiver is configured with a system identifier (SID) which distinguishes the deployable base station from commercial cellular networks thereby limiting access to the cellular telecommunication transceiver to cellular communication devices programmed with the SID.

9. A method for establishing emergency cellular telephone service, comprising:
locating a deployable base station in an emergency area,
establishing a communication link between the deployable base station and a network operation center via a satellite communication link;
receiving a voice call via cellular telephone communications at the deployable base station;
translating the voice call into voice-over IP data format;
transmitting the voice-over IP data via the satellite communication link to the network operation center;
receiving the voice-over IP data at the network operation center;
converting the voice-over IP data into pulse code modulation format suitable for transmission over a public switch telephone network; and
transmitting the voice call over the public switch telephone network.

10. The method of claim 5, further comprising:
comparing data encoded in the voice-over IP data to a home location registry database in the network operation center; and
routing the voice call via the public switch telephone network based upon the comparison.

11. The method of claim 5, further comprising assigning a system identifier (SID) to the deployable base station which distinguishes the deployable base station from commercial cellular networks thereby limiting access to the cellular telecommunication transceiver to cellular communication devices programmed with the SID.

12. The method of claim 5, further comprising establishing a meshed network including the deployable base station and the network operation center.
